(19) United States
(12) Patent Application Publication
(10) Pub. No.: US 2017/0220969 A9
(43) Pub. Date: Aug. 3, 2017

(54) System, method and process for authenticating product genuineness and supply chain management using Universal Product identifier Tag

(71) Applicant: Raja Sekhar Surapaneni, East Brunswick, NJ (US)

(72) Inventor: Raja Sekhar Surapaneni, East Brunswick, NJ (US)

(21) Appl. No.: 14/714,350

(22) Filed: May 18, 2015

Related U.S. Application Data
(60) Provisional application No. 61/955,234, filed on Mar. 19, 2014.

(51) Int. Cl. G06Q 10/06; G06K 19/06; G06F 17/30; G06Q 10/08; G06Q 30/00

(52) U.S. Cl. CPC G06Q 10/06315; G06Q 10/087; G06Q 30/018; G06F 17/30525; G06F 17/30867; G06F 17/30879; G06K 19/06028; G06K 19/06037

(57) ABSTRACT

The present disclosure provides for a system, method and process for product authentication, product tracking for use with products intended to be introduced for circulation into the Supply chain; including machine and human readable product identification data; comprising a product data storage and look up means, for general consumers or Supply chain intermediaries, wherein the UPIT is affixed to the product or embedded onto the product label and is arranged for inspection by a human or at least one reading device, remote from the product data storage means and at least one point in the product supply chain; wherein the human data entry lookup or at least one reading device is arranged to verify the authenticity of the machine readable product identification data and thereby verifying the authenticity of the product itself based on the last transaction of the product in the supply chain.

### BRIEF DESCRIPTION OF THE INVENTION

UPIT consists of both a visual authenticating Unique product identifier (UPI) for consumer recognition/verification in the form of an alpha numeric string and also a machine readable pattern/device containing the authenticating UPI data. The UPIT is affixed to any product or printed or embedded on the label by its manufacturer/owner/SC Intermediary before introducing the product into the supply chain. Each and every product in a batch that needs to be authenticated for genuineness in the future will be assigned an unique UPI. Currently most products manufactured carry different identifying barcodes (IBC) called UPC/EAN/JPN/ISBN/NDC or the like to identify the product lines and differentiate them from other products of the same manufacturer/owner. The proposed UPI is separate and additional to IBC and will enable tracking individual product in the supply chain. The UPIT can be linked to the product for its life cycle from manufacturing till consumption by the end user, employing a variety of means including a database which can be looked up by any person/entity seeking to identify if the product is Genuine or not. If a consumer or SC intermediary like Dealer/Distributor/Retailer/Govt. Officer needs to authenticate the product they can just scan the IBC and scan/read the UPIT in conjunction and look up if the product is genuine or not along with its supply chain history. A consumer carrying a smartphone can authenticate the product for genuineness easily using the camera on the smartphone for scanning the IBC or manually entering the IBC data into an application or webpage in conjunction with entering/reading/scanning the details of the UPIT into the online webpage or application liked to a database before even purchasing the product. This disclosure enables smooth and trustable buying/selling of products, thus improving trade and discouraging counterfeiters. This disclosure solves the issue of counterfeiting which is a major concern all over the world for manufacturers, governments and consumers alike. The UPIT can be used for other applications, such as providing product identity, manufacture details, conducting inventory management, pedigree data tracking and the like. This system represents an improvement over previous and currently available systems because it allows economical and innovative lookup of the product genuineness using a simple machine/human readable UPI in conjunction with the existing IBC rather than using complicated, expensive or unintuitive devices like special inks, hidden barcodes, holographic images and the like which need special expensive equipment to be manufactured/processed but may be easily duplicated if the counterfeiter decides to spend the money required to duplicate those devices. In this world of rampant counterfeit currency printing and advanced technologies any kind of special printing devices and algorithms are being easily reproduced. The combination of technologies employed in the present disclosure are very economical and secure because the UPIT is very inexpensive to create but the data looked up to authenticate products for genuineness is not readily accessible or reproducible by the counterfeiters given the fact that SC history of the product is linked to the lookup and counterfeiters though may be able to create a counterfeit UPIT tag, cannot create related SC history of the product without altering the employed remote secure databases and lookup technologies.

### BACKGROUND

The present disclosure relates to Universal Product Identifier Tag (UPIT) and more particularly to a machine readable device like a two dimensional barcode, a three-dimensional bar code, a QR code, RFID tag or Magnetic or the like machine readable tag, along with more of a sequence of alpha numeric digits incorporated on the product label or product packaging to enable product authentication of genuineness or enable its identification in the supply chain SC. The UPIT consists of Machine readable UPI, its equivalent in human readable alphanumeric characters and information of how to lookup the product for genuineness

There are different kinds of identifying bar codes, like Universal Product Code (UPC), European Article Number now renamed International Article Number (EAN), International Standard Book Number (ISBN), Amazon Standard Identification Number (ASIN) and Japanese Article Number (JAN), National drug Code (NDC) already in utility to identify and/or differentiate products from dis-similar products but none of the technologies can differentiate or identify a single product from the lot of similar products. The present disclosure identifies each item of the product line individually thereby enabling genuineness authentication, pedigree data management and SC management.

Counterfeiters are increasingly becoming a problem to product manufacturers, consumers, intermediaries and governmental bodies alike. Some Governmental bodies and big businesses have already mandated Individual product identification from manufacturer to end user for their own inventory purposes or to comply with different laws like pedigree laws. Technologies have been developed for individual product identification while the product is moved between locations in the SC. But no such technology has been implemented to help consumers flawlessly authenticate the genuineness of products with no additional devices to be purchased while assisting in SC management. All existing technologies are targeted at helping the business in the SC arena flawlessly while saving operational costs. Furthermore authenticating product genuineness with data obtained from the currently available technologies by customers is not possible because of (a) high cost of scanning/reading such data; (b)unavailability of encoded data deciphering algorithms due to security reasons and (c)lookup data not being made available to the consumers. The existing technologies of tracking product identification or the businesses that are developing them are certainly not to blame for the shortfall of not being able to cater to consumers because development costs for such high level technologies are prohibitive and cannot be recovered providing services to non-reimbursing customers. Any services targeted for the customers wouldn't generally be of practical use to the intermediaries in SC.

As it can be seen, there is a need for method to be developed catering to the provision of services to the end user/consumer enabling them to decide and identify the genuineness of the product they purchased or intend to purchase while enabling SC management.

### SUMMARY

In one aspect of the present disclosure a genuineness authentication system comprises of a computerized information system or service for generating an UPI or Manufacturer or Owner X or regulatory body supplied UPI for each product; a networked or online database storing the UPI and its IBC along with other relevant product details; and a computerized information retrieval system for looking up data associated with the UPI for display when looked up, where in the UPIT is incorporated into the product, product packaging or its label in a human, machine readable format and displaying the details of the last transaction/location on individual product as allowed by local law when looked up with a combination of the IBC and the UPI;

In another aspect of the present disclosure, a method of tracking the product location in the SC comprises assigning an UPI to the product using a computerized information system or service generated UPI or Manufacturer or Owner X or regulatory body supplied UPI; storing the UPI along with its IBC and with other relevant product details; incorporating the UPIT on the product, product packaging or its label; and looking up information about different transactions related to the products transportation history through the SC to identify the current location at the instance the UPI is looked up in conjunction to IBC in a networked or online database search request.

In another aspect of the present disclosure, a method of understanding Product demand or Identifying Product Placement or planning Product Promotions or determining Product pricing strategies comprises assigning an UPI to the product using a computerized information system or service generated UPI or Manufacturer or Owner X or regulatory body supplied UPI; storing the UPI along with other relevant product SC details like locations transported, pricing, shelf time, travel time and geographical transaction frequency; incorporating the UPIT on the product, product packaging or its label; looking up information in the form of different comparative studies based on the four P's of marketing about the Product in different scenarios when the UPI is looked up in conjunction to IBC in a networked or online database search request.

In another aspect of the present disclosure, a method of obtaining/verifying the current product stock along with all other details by the Manufacturer or Owner X or any intermediary or authorized users for different business decisions like future purchases comprises assigning an UPI to the product using a computerized information system or service generated UPI or Manufacturer or Owner X or regulatory body supplied UPI; storing the UPI along with other relevant sale, purchase and damage details; incorporating the UPIT on the product, product packaging or its label; and looking up information on the product stock when the UPI is looked up in conjunction with IBC in a networked or online database search request.

In another aspect of the present disclosure, a method of locating the products with in different stages of their shelf life in one or more storage/display locations so as to determine their shipping or promotion or pricing priorities by the Manufacturer or Owner X or any intermediary comprises assigning an UPI to the product using a computerized information system or service generated UPI or Manufacturer or Owner X or regulatory body supplied UPI; storing the UPI along with other relevant details like manufactured date, expiry date if any, shelf life status, storage location and the like; incorporating the UPIT on the product, product packaging or its label; and looking up information on the product location using a combination of UPI with IBC and sorting the products based on expiry date in a networked or online database search request.

In another aspect of the present disclosure, a method of forecasting product demand and varying manufacturing accordingly by the Manufacturer or Owner X comprises assigning an UPI to the product using a computerized information system or service generated UPI or Manufacturer or Owner X or regulatory body supplied UPI; storing the UPI along with other relevant sale/purchase transactions by the intermediaries in SC; incorporating the UPIT on the product, product packaging or its label; and looking up information of the product stock and sales frequencies at the intermediaries purchasing the products from the manufacturer or Owner X or another SC intermediary, using a combination of UPI with IBC in a networked or online database search request.

In another aspect of the present disclosure, a method of executing mandated or voluntary product recalls by the Manufacturer or Owner X or intermediaries comprises assigning an UPI to the product using a computerized information system or service generated UPI or Manufacturer or Owner X or regulatory body supplied UPI; storing the UPI along with the end user/consumer purchase details in a database as allowed by law; incorporating the UPIT on the product, product packaging or its label; and looking up information of the end users who have already purchased the product and the intermediaries who have product stock using a combination of UPI with IBC in a networked or online database search request.

In another aspect of the present disclosure, a method of disabling the sale/purchase/shipping of any recalled/tainted/controlled product between SC intermediaries or to the end user/consumers comprises assigning an UPI to the product using a computerized information system or service generated UPI or Manufacturer or Owner X or regulatory body supplied UPI; adding the recall data to the UPI data as allowed by law; incorporating the UPIT on the product, product packaging or its label; looking up the UPIT data for recall flags before allowing any sale transaction of the recalled products by the SC intermediaries using a combination of UPI with IBC in a networked or online database search request.

In another aspect of the present disclosure, a method of obtaining details of a counterfeit product sale/purchase from the authenticator; informing the same to manufacturer or Owner X and intermediaries for further investigation when a product fails to authenticate as genuine comprises assigning an UPI to the product using a computerized information system or service generated UPI or Manufacturer or Owner X or regulatory body supplied UPI; storing the UPI along with other relevant sale/purchase transactions in a database by the intermediaries in SC; incorporating the UPIT on the product, product packaging or its label; and looking up product genuineness using a combination of UPI with IBC in a networked or online database search request; displaying a message to the Authenticator that the product did not test out genuine; asking the authenticator to provide details of their purchase like retail store details, invoice copy, photo of the product and further displaying where genuine products are sold in the vicinity of the authenticator; and further providing an incentive to the authenticator to go and report the counterfeiter to the local authorities by displaying the details of the local authorities and providing them replacement product at a subsidized price if a proof of filing of such report is provided.

In another aspect of the present disclosure, a method of opening a dialogue or communication between the end user/consumer and Manufacturer or Owner X regarding the product, its uses/usage and its technical specifications, future and current promotions, product warranty management and related services comprises assigning an UPI to the product using a computerized information system or service generated UPI or Manufacturer or Owner X or regulatory body supplied UPI; storing the UPI along with other relevant sale/purchase transactions by the intermediaries in SC; incorporating the UPIT on the product, product packaging or its label; and allowing the end user/consumer Y and manufacturer or owner X or intermediaries to communicate through a telephone or network dialogue or web page or application or online chat room or asynchronous emails using a combination of UPI with IBC in a networked or online database search request.

In a future aspect of the present disclosure, a method of determining current ownership and history of ownership of a particular product (otherwise called as pedigree information) from the manufacturer to the end user/consumer through all the SC intermediaries comprises assigning an UPI to the product using a computerized information system or service generated UPI or Manufacturer or Owner X supplied UPI; adding the ownership detail to the UPI data on every SC transaction as allowed by law; incorporating the UPIT on the product, product packaging or its label; looking up the UPI data and delivering the pedigree data in any required format before any transaction on the product, by the SC intermediaries using a combination of UPI with IBC in a networked or online database search request.

These and other features, aspects and advantages of the present disclosure may be better understood with reference to the following drawings, descriptions and claims.

### BRIEF DESCRIPTION OF DRAWINGS

FIG. 1 is a perspective view of a Product having the UPIT displayed upon it according to an exemplary embodiment of the present disclosure. The IBC currently being used on products are retained as displayed.

FIG. 2 is a flow chart describing the use of an UPIT generated using UPI according to an exemplary embodiment of the present disclosure.

FIG. 3 is a flow chart describing the use of UPIT in the best currently contemplated modes and aspects of employment of modes in different scenarios based on requirement in the SC.

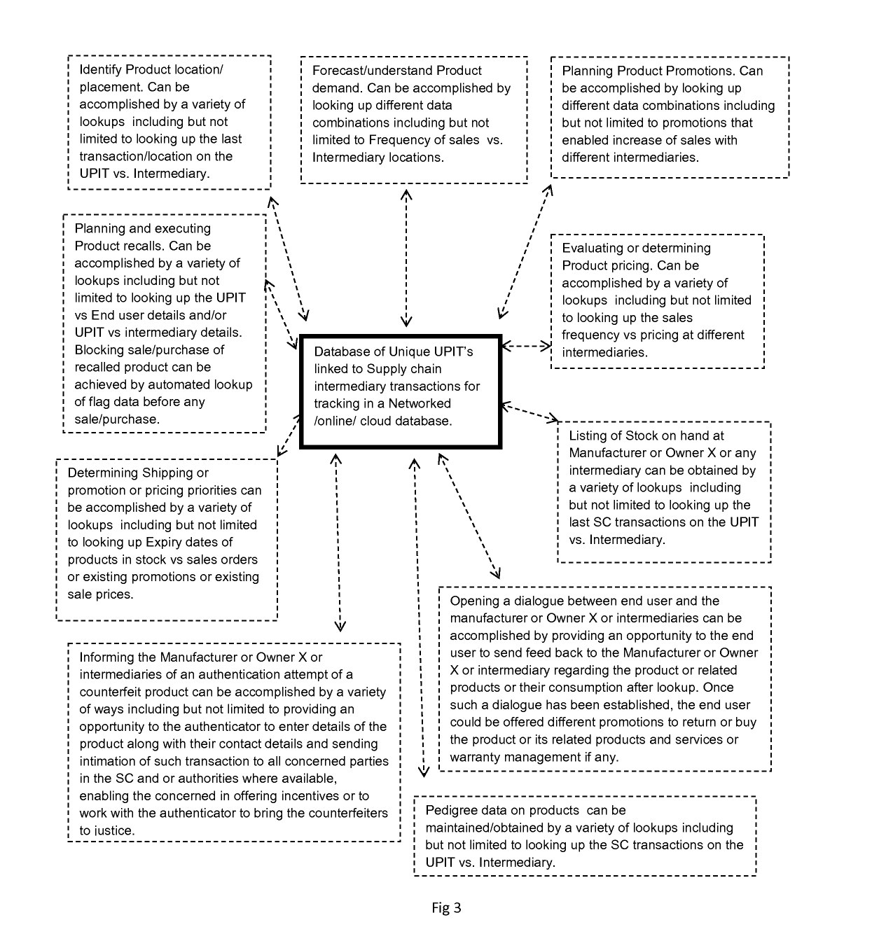

### DETAILED DESCRIPTION

The following detailed description depicts the best currently contemplated modes of carrying out exemplary embodiments of the disclosure. The description is not to be taken in a limiting sense, but is being made basically for the purpose of illustrating the general principals of the disclosure because the scope of any invention is best defined by appended claims.

Broadly, an embodiment of the present invention provides a machine readable tag UPIT disposed on any product that needs to be authenticated or identified in the SC and may be integrated into the product packaging permanently. The UPIT can be linked to the individual product by a variety of means including but not limited to a database containing the SC information of the product from its Manufacture to its consumption. If the end user/consumer of the product wishes to verify the product for genuineness then they can do so easily using the camera on their smartphone for scanning the IBC and entering/reading/scanning the details of the UPI into an online webpage or a smartphone app linked to a database before even purchasing the product. On such a scan the product SC details like which intermediary location has/had the product may be displayed, authenticating the location of the product and there by authenticating the product itself. Along with those details other information like the manufacturer or Owner X information, product details, promotions, manufacture date, batch number and expiry details can be displayed there on authenticating the product genuineness and providing incentive to the user to purchase the product without further hesitation and delay. The system of the present disclosure would eliminate the product genuineness concerns and facilitate confident purchases there by increasing productivity and resulting in customer satisfaction.

There is currently no genuineness authentication system to assure end users/consumers of the genuineness of the product and customers are left with the only choice of buying products from authorized dealers. The system of the present disclosure provides such a facility to authenticate the product for genuineness no matter where the underlying product is put for sale and/or purchased.

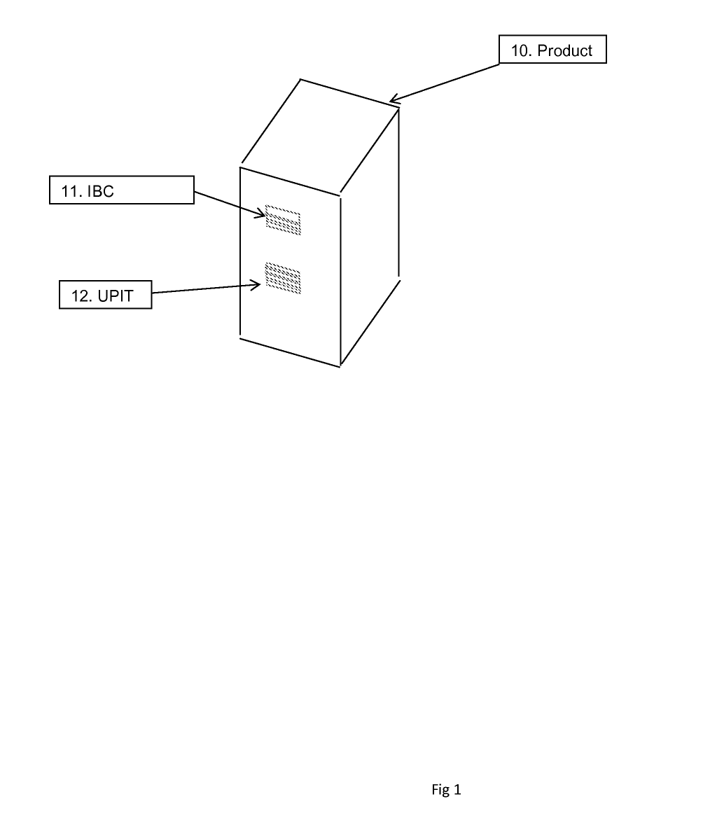

Referring to FIG. 1 the UPIT 12 may be included/integrated in the product 10 more particularly in a machine readable form, a two dimensional barcode, a three-dimensional bar code, a QR code, RFID tag or Magnetic tag or the like, along with more of a sequence of (alpha) numeric digits on its label or packaging. The UPIT 12 shall consist of Machine readable UPI, its value in human readable sequence of alphanumeric characters and information of how to lookup the product for genuineness. The UPIT 12 may be affixed to the Product 10 by various means like adhesive, by a separate hanging member (with items such as a chain, wire or the like) attached to the product 10 or by various other mechanisms. In some embodiments the UPIT may be integrated on the label of the product somewhere near the IBC 11 and/or a backup UPIT may be integrated into the product packaging.

The UPI may be liked to an UPIT database that ensures that each UPI is unique to product IBC. The UPIT database may be disposed on one or more computing systems and can be accessed by various means, i.e. through the internet, through a local, metropolitan or wide area network or the like. The data in the database may be stored on one or more server computers or on a cloud or parallel computing based storage. Access to the UPIT database lookups may be made available from a personal computer or smartphone via a client/server software, web markup language/service, web page or application.

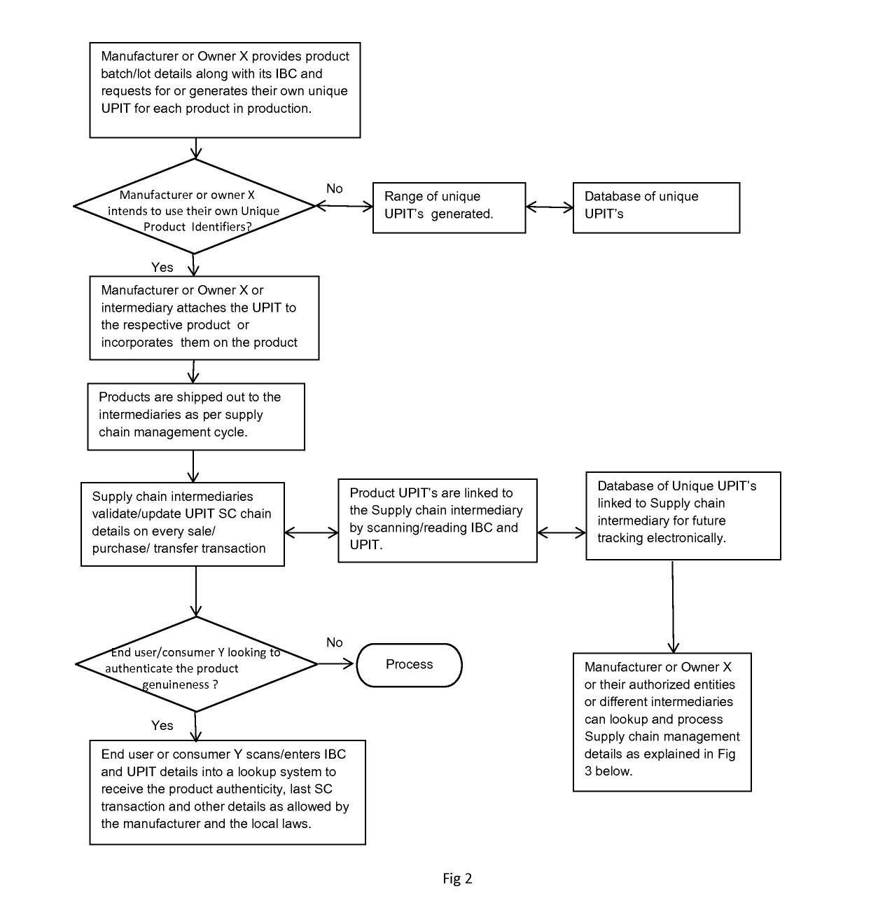

Referring now to FIG. 2 a manufacturer or owner X can request for an UPIT to be generated for a product with a particular IBC by providing their own or regulating body issued or employing system generated UPI's. Typically this request can be made through an online portal via internet or a Client server system connected to a network like MAN or a WAN or employing a web XML/UML service. The system of the present disclosure can generate an unique UPI that links the product thereto. The UPI so assigned to a product is stored in the UPIT database. The UPIT or details of making one may be sent to the requestor to be made and incorporated into the product or its label, for example. Once generated and incorporated onto the label, packaging or the product itself the UPIT is registered to the Manufacturer or Owner X in the UPIT database.

When the product is shipped between intermediaries of the SC like Manufacturer, Owner, Shipper, Exporter, Carrier, Importer, Distributor, Stockist, Wholesaler, Retailer or the like, every sale and purchase or transfer transaction is validated/updated by the intermediaries so the UPI is electronically attached to the particular intermediary in the system. The sequence of validation/update forms a linked list (or the like) of location of the Product between intermediaries in the UPIT database. When storing product in their warehouses the intermediary can update the UPIT database with exact storage location of the product for future lookup where appropriate. This updating of data can be automated owing to the Machine readable functionality of the UPIT and would allow easy product tracking for SC management and product shipment routing and other inventory management functions. In some embodiments the UPIT can be linked to the intermediary account number, invoice number, purchase order number and the like with their supplier intermediary to make such attachments in the UPIT database. Such attachments and linked list may be used as a security measure to ensure that each SC intermediary is attached the products which are actually paid for and received by them.

If the UPIT has not been attached to the Product at manufacturer or Owner X at the time of manufacture, the UPIT may be requested by a Manufacturer or SC intermediary and incorporated on to the Product or its packaging. In case the SC intermediary has requested for it with authorization from Manufacturer, the SC intermediary, may need to certify the authenticity and genuineness based on authorization from the manufacturer under penalty of perjury which shall be mentioned/displayed when the product is authenticated for genuineness in the future.

Various information attached to the UPIT's can be made available to users and SC intermediaries depending on their authorization and approval of the Manufacturer or owner of such information. For example, the shipping department will only be able to see the invoicing and shipment routing information connected to the intermediary and the retailer may be able to see the name and address of the end user/consumer. Further the end user/consumer will only be able to see the last retailer who sold the product and the manufacturer details and will not be able to see other SC intermediary details so as to protect the business prospects of the retailer.

Owners of information in the UPIT data will have the flexibility to decide the display of alternate identifying information than actual information for confidentiality purposes. For example, a retailer may decide he just wants to display the name and town of the end user/consumer than displaying his entire contact details when looked up.

In some embodiments of the current invention the UPIT data and its related data may be processed and/or mined for information and SC Management reports to achieve functionality in lot of ways including but not limited to the ones mentioned in different aspects of the present disclosure.

In some embodiments of the current disclosure the UPIT and its related data may be used in easing the work of authorities and protecting lives when human consumable food products are tracked using the UPIT. For example, the sale of expired and/or tainted products can be blocked with a software script reading expiry dates and/or recall flags from the UPIT related data without any manual intervention i.e. if the product is flagged as expired or tainted all the transactions on the product can be made to stop within seconds all over the world once such issue is identified. Authorities or the manufacturer would have the ability to identify products individually along their life cycle and recall them and forbid any further transactions on them without having to go through all the data and letting the SC intermediaries know manually about the issue with the product.

In some embodiments of the current disclosure the UPIT and its related data may be used in upholding and/or assisting in pedigree laws where the current ownership and history of ownership of a particular product is required to be maintained and delivered in different forms before every SC transaction to the buyer and/or submitted to different regulatory bodies as and when required.

In some embodiments, a Shipment Identifier Tag (SIT) may be generated to hold a list of products packed into a single package in the shipment being shipped or produced together, included in a Box or bag or shipped on a palette or truck to enable attachment to SC intermediaries en masse. Typically this can be done through an online portal via internet or a Client server system connected to a network like MAN or a WAN or employing a web XML/UML service. Typically the data included under a SIT may be list of UPI's; volume of the shipment (in Height, Width, Breadth); Net weight(packaged product weight); Gross(packaged products+packaging weight) weight of the shipment along with relevant product and shipment details. The product UPI's may be electronically attached to the SIT holding the list of products to enable SC management and shipment tracking, for example. In such embodiments SIT's may be attached to SC intermediaries than attaching the actual UPIT's until the SC intermediary actually decides to unpack, store or repackage the shipments. This can be used to reduce manual labor or machine read time to scan/read all the UPIT's and attach them to the SC intermediary location. The receiving SC intermediary will how ever be able to verify and validate the receipt of the shipment and the UPIT's of the product's it is actually received. Once the shipment is received at the SC intermediary, they may decide to unpack/repack the shipment for which the UPIT's shall be attached to the SC Intermediary for repacking/storage/SC management purposes. This way the ownership of product will be tracked in every and all forms of ownership while passing through every SC intermediary and shipment carrier until the end user/consumer purchase making the process in compliance with any pedigree laws.

It should be understood, of course, that the foregoing relates to exemplary embodiments of the disclosure and that modifications may be made without departing from the spirit and scope of the invention as set forth in the following claims.

What is claimed is:

1. An Individual product identification and tracking system comprising:
a computerized system for assigning and/or generating or using a pre generated UPI for a product;
a database storing the UPI and the IBC of the product; and
a computerized information retrieval system for looking up data associated with the UPIT; and
a computerized information system for adding data to the existing UPIT database;
where in the UPIT is provided as machine readable device along with human readable details printed on it, in a form Integrated into the product label or product packaging.

2. The identification system of claim 1, a reader system for scanning/reading the machine readable UPIT at any SC intermediary location determining the Product location, ownership and other SC management details.

3. The identification system of claim 1, where in the computerized information retrieval system provides authentication of genuineness of the Product having the UPIT integrated into its label or packaging there to.

4. A method of tracking individual items through their SC life cycle comprising:
assigning an UPIT to every product being manufactured or being sold into the SC chain for future sale to an end user/consumer;
storing the UPI and the details of the assigned Product in a database;
integrating the UPIT into the product, product packaging or its label; and
looking up product information when the UPI Is entered into a database search request.

5. The method embodied in claim 4, where in items are products which are currently in the supply chain and may be sold in the future in retail for consumption by an end user/consumer.

6. The method of claim 5, further comprising of tracking the Product from the point of manufacture till consumption by its end user, each time the product is moved between locations or SC intermediaries.

7. A method embodying claim 5, further looking up information about different transactions related to the products transportation through the SC to identify the last location when the UPIT is looked up in conjunction to IBC in a networked or online database search request.

8. A method embodying claim 5, further understanding Product demand or Identifying Product Placement or planning Product Promotions or determining Product pricing strategies comprising:
storing the UPI along with other relevant product SC details like locations transported, pricing, shelf time, travel time and geographical transaction frequency;
looking up information in the form of different comparative studies based on the four P's of marketing about the Product in different scenarios when the UPI is looked up in conjunction to IBC in a networked or online database search request.

9. A method embodying claim 5, further obtaining/verifying the current product stock along with all other details by the Manufacturer or Owner X or any intermediary or authorized users for different business decisions like future purchases comprising:
storing the UPI along with other relevant sale, purchase and damage details;
and looking up information on the product stock when the UPI is looked up in conjunction with IBC in a networked or online database search request.

10. A method embodying claim 5, further locating the products with in different stages of their shelf life in one or more storage/display locations so as to determine their shipping or promotion or pricing priorities by the Manufacturer or Owner X or any intermediary comprising:
storing the UPI along with other relevant details like manufactured date, expiry date if any, shelf life status, storage location and the like;
and looking up information on the product location using a combination of UPI with IBC and sorting the items based on expiry date in a networked or online database search request.

11. A method embodying claim 5, further forecasting product demand and varying manufacturing by the Manufacturer or Owner X comprising
storing the UPI along with other relevant sale/purchase transactions by the intermediaries in SC;
and looking up information of the product stock and sales frequencies at the intermediaries purchasing the products from the manufacturer or another SC intermediary below the Manufacturer or Owner X using a combination of UPI with IBC in a networked or online database search request.

12. A method embodying claim 5, further executing mandated or voluntary product recalls by the Manufacturer or Owner X or regulatory bodies or intermediaries comprising:
storing the UPI along with the end user purchase details as allowed by law;
and looking up information of the end users who have already purchased the product and the intermediaries who have product stock using a combination of UPI with IBC in a networked or online database search request.

13. A method embodying claim 5, further disabling the sale/purchase/shipping of any recalled/tainted/controlled product between SC intermediaries or to the end user/consumers comprising:
adding the recall information to the UPIT data as allowed by law;
looking up the UPI data for recall flags before allowing any sale transaction of the recalled products by the SC intermediaries using a combination of UPI with IBC in a networked or online database search request.

14. A method embodying claim 5, further obtaining details of a counterfeit product purchase from the authenticator; informing the same to manufacturer or Owner X or regulatory bodies and intermediaries for further investigation when a product fails to authenticate as genuine comprising:
storing the UPI along with other relevant sale/purchase transactions by the intermediaries in SC;
looking up product genuineness using a combination of UPI with IBC in a networked or online database search request;
displaying a message to the Authenticator that the product did not test out genuine and asking the authenticator to provide details of their purchase like retail details, invoice copy, photo of the product and further displaying where genuine products are sold in the vicinity of the authenticator;
and further providing an incentive to the authenticator to go and report the counterfeiter to the local authorities by displaying the details of the local authorities and providing them replacement product at a subsidized price.

15. A method embodying claim 5, further opening a dialogue or communication between the end user and Manufacturer or Owner X regarding the product, its uses/usage and its technical specifications, future and current promotions, product warranty management and related services comprising:
storing the UPI along with other relevant sale/purchase transactions by the intermediaries in SC;
and allowing the end user and manufacturer or owner X or intermediaries communicate through a telephone or network dialogue or online chat room or asynchronous emails using a combination of UPI with IBC in a networked or online database search request.

16. A method embodying claim 5, further maintaining the history of previous ownership and other pedigree information as required by different regulatory bodies and related services comprising:
storing the UPI along with other relevant sale/purchase transactions by the intermediaries in SC in a linked list or other format;
and displaying of ownership and transaction information right from point of manufacture to the current location by looking up a combination of UPI with IBC in a networked or online database search request.

17. A method embodying claim 5, further helping in authentication of the products genuineness comprising
Storing the count of lookup's done on every product and intimating the current owner and every owner in the SC history of the product on the count of lookup's done once the count of lookup's crosses a preset number.
Displaying the total count of lookup's done on the product (they are trying to lookup) for every following lookup on the product thus enabling the user to decide for themselves if they would like to enquire more on the genuineness of the product.
Providing an option of changing identification information mentioned in claim 1, for a product while in the SC on the request of Manufacturer or the current owner, to enable blocking the sales of any counterfeits of the product.

18. A method embodying claim 5 supporting data search/lookup for all the claims 1 to 17 above where search/lookup is submitted in one or more of the following methods and results rendered/returned/displayed in one or more of the following methods
On a web server or browser
On a soft/firm/hard ware running on a computer system
On a hand held computing/gaming/lookup device
On a computing/gaming/lookup device
On a soft/firm/hard ware computing assisted device
On a mobile/regular phone with mobile or telephony application
On a regular/mobile phone with touch tones
On a regular/mobile phone with voice recognition
On a regular/mobile phone with manual/auto assistance
SMS/Text/online/email messaging
On a computer system
On a database server, middle ware routine or client
Although particular embodiments of the disclosure have been illustrated and described, various changes may be made in the form, composition, construction, and arrangement of the parts herein without sacrificing any of its advantages. Therefore, it is to be understood that all matter herein is to be interpreted as illustrative and not in any limiting sense, and it is intended to cover in the appended claims such modifications as come within the true spirit and scope of the invention.
